(19) United States
(12) Patent Application Publication
(10) Pub. No.: US 2014/0150244 A1
(43) Pub. Date: Jun. 5, 2014

(54) ADHESIVE-FREE CARRIER ASSEMBLIES FOR GLASS SUBSTRATES

(71) Applicant: GENERAL ELECTRIC COMPANY, Schenectady, NY (US)

(72) Inventors: Jie Jerry LIU, Niskayuna, NY (US); Jeffrey Michael YOUMANS, Niskayuna, NY (US)

(73) Assignee: GENERAL ELECTRIC COMPANY, Schenectady, NY (US)

(21) Appl. No.: 13/690,280

(22) Filed: Nov. 30, 2012

(51) Int. Cl. C03B 35/00; B23Q 3/00

(52) U.S. Cl. CPC C03B 35/00; B23Q 3/00
USPC 29/559; 269/289 R; 269/13

(57) ABSTRACT

The disclosure relates generally to carrier assemblies for handling and processing thin flexible glass. More particularly, the invention relates to an adhesive-free carrier assembly for handling thin flexible glass substrates that are used in organic opto-electronic devices such as OLEDs and organic photodetectors (OPDs).

### BACKGROUND

The invention relates generally to the handling and processing of thin flexible glass. More particularly, the invention relates to carrier assemblies for handling thin flexible glass substrates used in opto-electronic devices.

Thin flexible glass substrates are useful for making flexible or conformable devices, especially opto-electronic devices based on organic semiconductors such as organic light-emitting diodes (OLEDs), organic photodiodes (OPDs), organic field effect transistors (OFETs) and organic photovoltaic devices (OPVs). The thickness of organic layers employed in the devices is generally less than 1 micron, usually on the order of 100-200 nm. Thus the substrate used is preferred to have a flat surface to ensure the coating uniformity. However, the thin flexible glass itself does not have the mechanical stiffness required to obtain the desired flatness.

Temporary bonding/debonding technologies have been developed to address similar issue encountered for other types of flexible substrates such as flexible plastic substrates. In general, the temporary bonding uses an adhesive layer that temporarily joins the flexible substrate to a rigid carrier such as glass. After the fabrication process, the flexible substrates can be detached from the rigid carrier substrate. FIG. 1 shows a schematic of the conventional bonding/debonding process.

The temporary bonding/debonding technologies optimized for plastic substrates so far are not well compatible with flexible glass. First, the adhesive material may have different coefficient of thermal expansion (CTE). For example, the 100 μm thin glass tested has a CTE of <10 ppm/C, where most organic adhesive materials usually have a much greater CTE of approximately 100 ppm/C or greater. The difference in CTE causes warping, bowing, delamination, breakage & rupture. Second, the debonding process, usually performed in the end of the fabrication process, becomes difficult and delicate because the thin glass is very fragile and subject to breaking if not handled carefully.

Thus, there is a need in the art for new and improved carrier assembly systems for handling and processing thin flexible glass substrates.

### SUMMARY

Aspects of the present disclosure provide a carrier assembly that is adhesive-free and is suitable for handling and processing thin flexible glass substrates that are used for organic opto-electronic devices such as OLEDs, OPDs, PFETs and OPVs. Though some aspect of the disclosure may be directed toward the fabrication of components for the semiconductor industry, for example, computer components, including displays and monitors, aspects of the present disclosure may be employed in the fabrication of any component in any industry, in particular, those components that require carrier assemblies for handling thin flexible glass substrates.

One aspect of the present disclosure is directed to an adhesive free carrier assembly. The carrier assembly comprises a rigid carrier and a flexible substrate, wherein the rigid carrier is directly attached to the flexible substrate without the use of an adhesive to form the adhesive free carrier assembly. In one embodiment, a portion of the flexible substrate extends beyond the rigid substrate. In another embodiment, a portion of the rigid carrier surface that contacts the flexible substrate is roughened. In a related embodiment, a portion of the perimeter of the rigid carrier is roughened. In one example, a portion of the perimeter of the rigid carrier is covered with a decoupler. The decoupler, in one example, is from about 10 nanometers to about 1000 micrometers thick. In another example the decoupler can be about 25 to 100 micrometers thick. In one example, at least a portion of the flexible substrate is positioned above the decoupler.

In one embodiment of the adhesive free carrier assembly, before the rigid carrier and the flexible substrate are contacted together, at least a portion of the rigid carrier is coated with an inorganic coating. The inorganic coating has, in one example, similar chemical composition to the flexible substrate or sticks to the flexible substrate. In one example of the adhesive free carrier assembly, before the rigid carrier and the flexible substrate are contacted together, at least a portion of the flexible substrate is coated with an inorganic coating.

One aspect of the present disclosure is an adhesive free carrier assembly. The carrier assembly comprises a rigid carrier having at least a portion of its perimeter etched to provide a step; and a flexible substrate, wherein the rigid carrier is directly contacted to the flexible substrate without the use of an adhesive to form the adhesive free carrier assembly, and wherein at least a portion of the flexible substrate is positioned above the step.

Another aspect of the present disclosure is an adhesive free carrier assembly, comprising a rigid carrier having at least a portion of its perimeter etched to provide a step; and a decoupler covering a portion of the step; and a flexible substrate, wherein the rigid carrier is directly contacted to the flexible substrate without the use of an adhesive to form the adhesive free carrier assembly, and wherein at least a portion of the flexible substrate is positioned above the decoupler.

In one example of the adhesive free carrier assembly, the depth of the step and the height of the decoupler are optimized in such a way that the difference in height of the top surface of the decoupler to the rest of the rigid carrier is from about 10 nanometers to 100 micrometers. In another example, this distance is about 10 micrometers to 100 micrometers.

One aspect of the present disclosure is a method for handling and/or processing thin flexible substrates. The method comprises providing a rigid carrier; providing a flexible substrate; directly contacting the rigid carrier onto the flexible substrate without the use of adhesive to form a carrier assembly; fabricating a device on top of the carrier assembly, wherein the device and flexible substrate are linked together; and decoupling the rigid carrier from the device-flexible substrate component. The thin flexible substrate can, in one example, be glass. In another example, a portion of the perimeter of the rigid carrier is roughened or etched before it is contacted with the flexible substrate. A portion of the perimeter of the rigid carrier is, in one example, covered with a decoupler.

In the presently taught method, before the rigid carrier and the flexible substrate are contacted together, in one example, at least a portion of the rigid carrier is coated with an inorganic coating. In another example, before the rigid carrier and the flexible substrate are contacted together, at least a portion of the flexible substrate is coated with an inorganic coating.

The carrier assembly may further include a device disposed on the flexible glass substrate, and an encapsulation layer covering the device to form a hermetic seal for the device. The device may be at least one of an electronic device, an optoelectronic device, an optical device, a light-emitting device, an OLED device, an organic semiconducting device, an LCD display device, a photovoltaic device, a thin-film sensor, and an evanescent waveguide sensor.

These and other aspects, features, and advantages of this disclosure will become apparent from the following detailed description of the various aspects of the disclosure taken in conjunction with the accompanying drawings.

### BRIEF DESCRIPTION OF THE FIGURES

The subject matter, which is regarded as the invention, is particularly pointed out and distinctly claimed in the claims at the conclusion of the specification. The foregoing and other features, aspects, and advantages of the disclosure will be readily understood from the following detailed description of aspects of the invention taken in conjunction with the accompanying drawings, wherein:

FIG. 1 shows a side view schematic of the existing bonding/debonding process and carrier assembly.

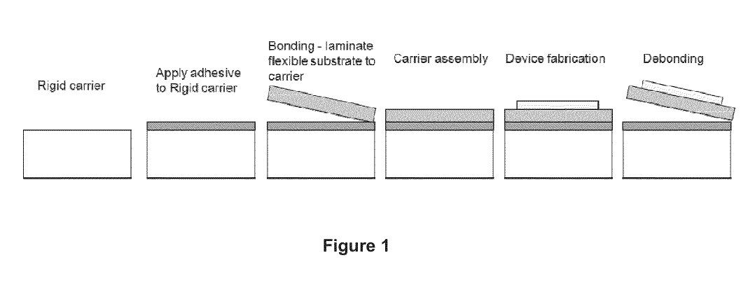

FIG. 2 shows a side view schematic of the presently taught carrier assembly for a flexible substrate. The schematic shows the adhesive-free joining process and carrier assembly of the present disclosure.

FIG. 3 shows a side view schematic of one embodiment of the presently taught carrier assembly, in which the flexible substrate and rigid carrier are a match such that one side of the flexible substrate fully contacts with one side of the rigid carrier.

FIG. 4 shows a side view schematic of an embodiment of the present disclosure, showing an example where a portion of the rigid carrier is etched off such that when the flexible substrate contacts the rigid carrier, a portion of the flexible substrate is positioned above the etched portion of the rigid carrier.

FIG. 5 shows a schematic of an example of the present disclosure, showing a portion of the rigid carrier that is roughened such that when the flexible substrate contacts the rigid carrier, a portion of the flexible substrate is positioned above the roughened portion of the rigid carrier.

FIG. 6 shows a schematic of an example of the present disclosure, showing side views of an example where a decoupler (such as a coating of organic material or a plastic tape such as Kapton) is applied to a portion of the perimeter of the rigid carrier (e.g. a corner or an edge). In this example, a one-sided Kapton tape was used as the decoupler. The decoupler has a thickness less than about 1 mm, or preferably less than about 100 μm. The rigid carrier is aligned to the flexible substrate (flexible sheet of glass), and the flexible substrate is positioned such that at least a portion of the flexible substrate is positioned above the decoupler. The flexible substrate is contacted with the rigid carrier and decoupler by applying pressure to bring the flexible substrate in contact with the rigid carrier to form a carrier assembly.

FIG. 7 shows a schematic of an example of the present disclosure, showing a portion of the rigid carrier is etched off, a decoupler is applied to the etched off portion of the rigid carrier, and a flexible substrate is contacted with the rigid carrier and decoupler to form a carrier assembly. Schematics 701-704 are side views. 705 and 706 are top views, showing that the decoupler is applied along the edge and the corner of the rigid carrier.

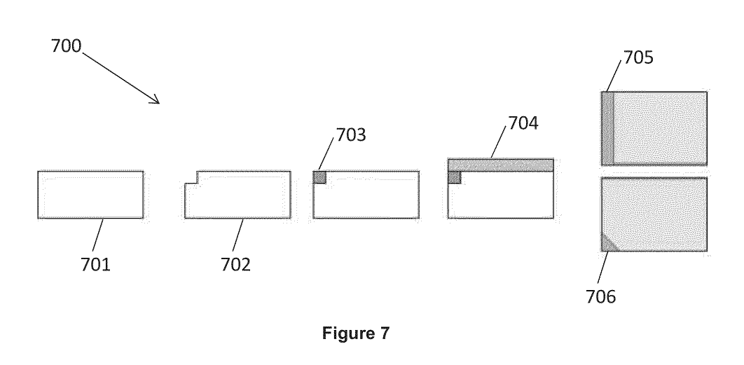

FIG. 8 shows a side view schematic of an example of the present disclosure, showing the coating of a rigid carrier with inorganic coating (such as SiO₂, Na₂O) that either has similar chemical composition to the flexible substrate or sticks to the flexible substrate. The rigid carrier is then aligned to a flexible glass sheet that requires processing in such a way that at least a portion of the flexible glass is in intimate contact with the inorganic coating. Pressure is applied to bring the flexible substrate and rigid carrier in contact.

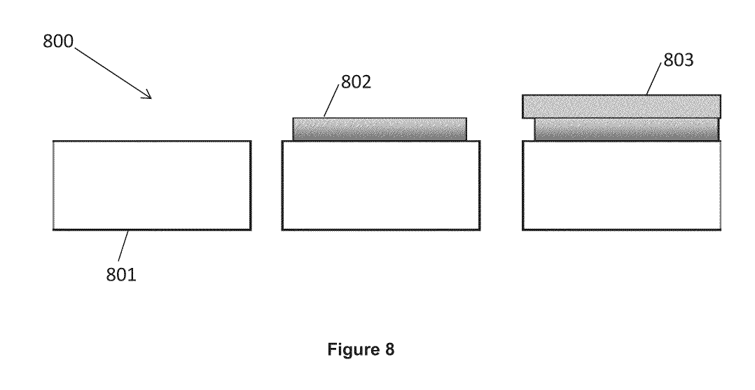

FIG. 9 shows a flow chart, in accordance with aspects of the disclosure, illustrating a method for handling and/or processing thin flexible substrates.

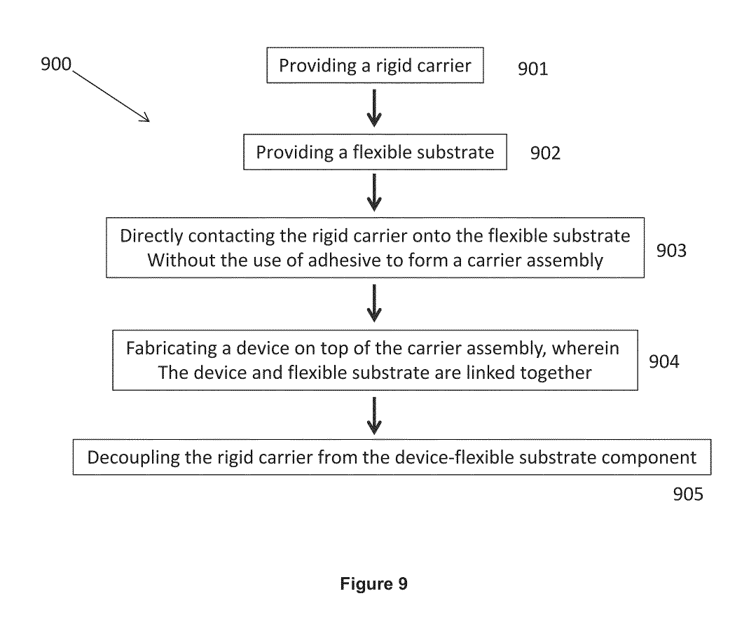

### DETAILED DESCRIPTION

Reference will be made below in detail to exemplary embodiments of the invention, examples of which are illustrated in the accompanying drawings. Wherever possible, the same reference numerals used throughout the drawings refer to the same or like parts.

The present disclosure relates generally to the field of opto-electronic devices, and, specifically, to the field of carrier assemblies used for the processing and handling of flexible substrates. In particular, aspects of the present disclosure provide a carrier assembly that is adhesive-free and is suitable for handling and processing thin flexible glass substrates that are used for organic opto-electronic devices such as OLEDs and organic photodetectors (OPDs). In the instant application, “organic opto-electronic device,” includes, but is not limited to, organic light-emitting devices (“OLEDs”), organic photodiodes (“OPDs”), organic photovoltaic devices (“OPVs”), and organic thin-film transistors (“TFTs”).

Though some aspect of the disclosure may be directed toward the fabrication of components for the semiconductor industry, for example, computer and television displays and components related thereto, aspects of the present disclosure may be employed in the fabrication of any component in any industry, in particular, those components that require carrier assemblies for handling thin flexible glass substrates.

With the continuing evolvement of the electronics industry, new techniques are continually needed to allow not only incremental progress, but also (albeit typically less often) major technological leaps that become the impetus for another round of incremental progress. For example, in the manufacturing of displays, for example, flat-panel displays such as video, television and computer monitors, among others, substrate sizes have been increasing incrementally over the approximately seven generations of flat panel display technology. However, these ever-increasing substrate sizes create significant manufacturing and engineering challenges with regard to their use, handling and transportation. In addition, the upfront capital investment in infrastructure required to process these large sheets of glass for each subsequent generation of fabrication is in the billions of dollars per fabrication facility.

To counter this and to service future flexible display needs, attempts have been made to develop manufacturing processes that would allow for roll-to-roll, or reel-to-reel (also called “web coaters”), technologies. These technologies would allow flexible substrates, such as polymer/plastic foils and metal foils, to be substituted for rigid glass substrates. However, attempts so far have had limited success, primarily due to the complexity of manufacturing active electronic devices, such as field-effect transistors (FETs) that form the basis of most electronic circuitry (note that thin-film transistors (TFTs) are typically in the form of FETs). Typical manufacturing of such devices that use flexible substrates requires multiple coatings deposited at high temperatures and interspaced with multiple photolithographic patterning steps. The manufacturing process of such devices requires delicate handling of thin substrates, such as thin glass substrates, and specialized carrier systems for the processing and handling of such substrates that are used in the device manufacturing process.

Here, the inventors of the instant application have discovered a method of handling and processing thin flexible glass substrates. The first step includes a particular series of steps in order to provide a sufficiently smooth surface area of the starting rigid substrate and the flexible substrate. These steps include first loading the glass into a processing unit, and subsequently washing the glass with acetone, followed by washes with isopropanol, and subsequently with deionized water. The glass substrates were then cleaned further in an ultrasonic bath, washed with deionized water and dried with nitrogen.

Once the inventors prepared the substrate by this method, they discovered that the surface of the glass substrate is very smooth and allows for two substrates, namely a thin flexible glass and a rigid flexible carrier, to be strongly adhered together once in contact with one another. That is, the inventors of the instant application discovered that it is possible to avoid the use of adhesives, which have certain disadvantages as well as adding an extra manufacturing step, and still be able to obtain the desired outcome of effectively handling and processing thin flexible glass substrates.

One aspect of the present disclosure is an adhesive free carrier assembly where the rigid carrier and flexible substrate are directly attached to one another without the use of an adhesive, forming the adhesive free carrier assembly. A portion of the flexible substrate, in one example, extends beyond the rigid substrate and this is used as a means to more easily separate the two substrates from one another. In another embodiment, a portion of the rigid carrier surface that contacts the flexible substrate is roughened. This roughened portion can be the perimeter of the rigid carrier or the edge or corner of the rigid carrier. Alternatively, a portion of the perimeter of the rigid carrier can be covered with a decoupler of varying sizes, including from about 10 nanometers to about 1000 micrometers thick, or from about 25 to 100 micrometers thick. At least a portion of the flexible substrate can, in some cases, be positioned above the decoupler. Using the roughening approach or the approach of using a decoupler provides a mechanism by which the inventors could easily separate the flexible thin substrate from the rigid glass substrate.

Some aspects of the present disclosure relate to the field of flexible substrates and specifically to the processing and handling of flexible displays and flexible electronics. In these application areas, there are existing short term and long term needs for substrates that exhibit improvements in durability, thickness, weight, bend radius, and cost. There is a desire for flexible substrates having dimensional stability, matched CTE, toughness, transparency, thermal capability, and barrier properties and/or hermeticity suitable for active matrix display fabrication. Metal (e.g., stainless steel), thermoplastics (e.g., Polyethylene naphthalate (PEN), Polyethersulfone (PES), Polycarbonate (PC), Polyethylene terephthalate (PET), Polypropylene (PP), oriented polypropylene (OPP)), and glass (e.g., borosilicate) substrates may be used for these applications. In one example, the thin flexible substrate is a thin flexible sheet of glass. The handling and processing of such delicate substrates, including thin flexible sheets of glass, requires specialized carrier assemblies and related processes.

Embodiments of the invention described herein relate to carrier assemblies. The packaged opto-electronic device includes an opto-electronic device that is sandwiched between two barrier layers. Opto-electronic devices generally include a wide array of devices that include light emitting devices used in display systems or photovoltaic devices used in energy generation systems. Opto-electronic devices are structured to include an active layer disposed between two electrodes. In light emitting devices, when a power source connected between the two electrodes supplies electric energy to the two electrodes, current flows through the active layer and causes the active layer to emit light. On the other hand, in photovoltaic devices the active layer absorbs energy from light and converts this energy into electric energy. The electric energy can be fed to a load by connecting the load between the two electrodes of the photovoltaic device.

Organic light-emitting diodes, or OLEDs, are examples of solid-state opto-electronic devices that can have several layers of organic material and polymers. Opto-electronic devices, especially OLEDs, are generally prone to degradation under ambient environment conditions. For example, a common problem with OLED displays is sensitivity to moisture. The water related degradation often manifests itself as the growth of dark spots in the emissive areas of the OLED, which can lead to performance loss, operational instability, poor color and emission accuracies, and shortened operational life.

During the fabrication of such electronic devices, handling and processing of the substrates, in particular the handling and processing of flexible glass substrates, is an important consideration. This is because opto-electronic devices, such as organic light emitting devices (OLEDs), generally comprise thin film layers formed on a substrate such as glass or silicon. A light-emitting layer of a luminescent organic solid, as well as optional adjacent semiconductor layers, is sandwiched between a cathode and an anode.

OLEDs have a number of beneficial characteristics, such as a low activation voltage, quick response, high brightness, high visibility, and uncomplicated process of fabrication. Thus, the OLEDs represent a promising technology for display applications and for general illumination. The fabrication of such devices on carrier assemblies, and improvements in carrier assembly technologies themselves and methods for their use can provide new and improved methods for creating such electronic devices on thin flexible substrates.

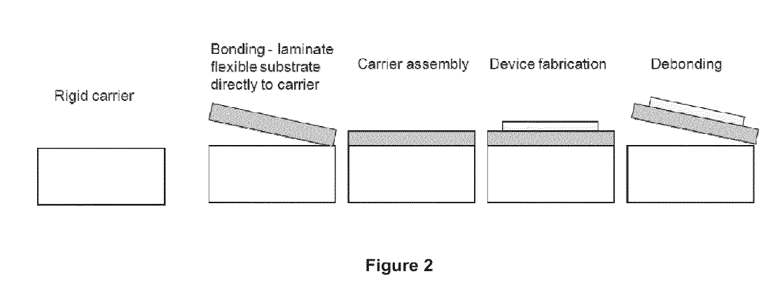

Here, the inventors of the instant application conceived that a flat glass substrate with a sufficiently clean and smooth surface will adhere well to another glass substrate with similar surface properties due to Van Der Waal force of adhesion present at the interface. Further, the inventors conceived that since glass substrates used for opto-electronic applications are generally very smooth (with an average roughness value of 1 nm or less), they can firmly adhere to each other when pressed into contact, and that flexible glass substrates would adhere to a rigid glass carrier even better than two rigid glass sheets due to the conformability of the flexible glass substrate. The inventors of the instant disclosure further showed that adhesive-less joining of a rigid substrate with a flexible substrate, such as a flexible glass substrate, is strong enough to go through typical device fabrication steps such as cleaning, etching, thermal baking, and vacuum deposition (see FIG. 2). Once the device fabrication process ends, the inventors showed that the flexible glass substrates can be easily peeled off from the rigid carrier substrate. The rigid carrier may be a rigid glass sheet or a silicon wafer.

One aspect of the present disclosure is directed to an adhesive free carrier assembly. The carrier assembly comprises rigid carrier 301 and a flexible substrate 302, wherein the rigid carrier is directly attached to the flexible substrate without the use of an adhesive to form the adhesive free carrier assembly 303. A portion of the flexible substrate can extend beyond the rigid substrate, and in another example, a portion of the rigid carrier surface that contacts the flexible substrate is roughened. A portion of the perimeter of the rigid carrier can also be roughened. In one example, a portion of the perimeter of the rigid carrier is covered with a decoupler. The decoupler, in one example, is from about 10 nanometers to about 1000 micrometers thick, or the decoupler is from about 25 micrometers to 100 micrometers thick. In a particular embodiment, the decoupler is about 50 micrometers thick. In another embodiment, the decoupler is about 10 μm, about 20 μm, about 30 μm, about 40 μm, about 50 μm, about 70 μm, about 100 μm or about 200 μm thick. In one embodiment, at least a portion of the flexible substrate is positioned above the decoupler.

The present disclosure is also directed to an adhesive free carrier assembly 400, which comprises rigid carrier 401 and a flexible substrate 403. The rigid carrier 401 has at least a portion of its perimeter etched to provide a rigid carrier with a step 402, and this rigid carrier 402 is directly contacted to the flexible substrate 403 without the use of an adhesive to form the adhesive free carrier assembly 404, such that at least a portion of the flexible substrate 403 is positioned above the step of the rigid carrier with a step 402. The placement of the step in the rigid carrier and the flexible substrate that is positioned above the step enables easy separation and handling of the flexible substrate. The flexible substrate is grabbed at the edge where the rigid carrier has a step, and using small movements of the flexible substrate, it is possible to begin separating the flexible substrate from the rigid substrate.

As such, one aspect of the present disclosure is an adhesive free carrier assembly where a rigid carrier has at least a portion of its perimeter etched to provide a step; and a flexible substrate, such that the rigid carrier is directly contacted to the flexible substrate without the use of an adhesive to form the adhesive free carrier assembly, and such that at least a portion of the flexible substrate is positioned above the step.

The present disclosure is also directed to an adhesive free carrier assembly 500, which comprises a rigid carrier 501 having at least a portion of its perimeter roughened to provide a rigid carrier 502 with roughened corner 503. The adhesive free carrier assembly 500 comprises a rigid carrier 502 with roughened corner 503, as well as a flexible substrate 504. The rigid carrier is directly contacted to the flexible substrate without the use of an adhesive to form the adhesive free carrier assembly, and at least a portion of the flexible substrate 504 is positioned above the roughened corner 503 of the rigid carrier 502. The roughening process may be performed on the rigid carrier 501 at one edge (or corner) 506. The rigid carrier 501 can be roughened along the perimeter 505 of the rigid carrier.

In one embodiment, a portion of the perimeter of the rigid carrier 601 is covered with a decoupler 602. A portion of the perimeter (such as a corner, a portion of an edge) of the rigid carrier was covered with decoupler 602 (such as a coating of organic material or a plastic tape such as Kapton) where the decoupler has a thickness less than 1 mm, or preferably less than 0.1 mm. The rigid carrier 601 was aligned to flexible glass sheet 603 such that at least a portion of flexible glass 603 is positioned above decoupler 602. Pressure is then applied to bring the flexible glass into contact with the rigid carrier.

The present disclosure is therefore also directed to an adhesive free carrier assembly, comprising a rigid carrier having at least a portion of its perimeter etched to provide a step; and a decoupler covering a portion of the step; and a flexible substrate, such that the rigid carrier is directly contacted to the flexible substrate without the use of an adhesive to form the adhesive free carrier assembly, and such that at least a portion of the flexible substrate is positioned above the decoupler.

The present disclosure is also directed to an adhesive free carrier assembly 700, which comprises a rigid carrier 701 having at least a portion of its perimeter etched to provide a rigid carrier with a step 702. The adhesive free carrier assembly 700 also comprises a decoupler 703 covering a portion of the step, as well as a flexible substrate 704. The rigid carrier is directly contacted to the flexible substrate without the use of an adhesive to form the adhesive free carrier assembly, and at least a portion of the flexible substrate 704 is positioned above the decoupler 703. The decoupler 703 may be applied to the rigid carrier at one edge (or corner) 706 that has a section etched to provide a rigid carrier 701 with a step 706. In examples where the perimeter of the rigid carrier 701 is etched, the decoupler 703 can be applied to the etched perimeter 705 of the rigid carrier 701. In one example of the adhesive free carrier assembly, the depth of the step and the height of the decoupler are optimized in such a way that the difference in height of the top surface of the decoupler to the rest of the rigid carrier is from about 10 nanometers to 100 micrometers. In another example, this distance is about 10 micrometers to 100 micrometers.

In one embodiment of the presently taught method, before rigid carrier 801 and flexible substrate 803 are contacted together, at least a portion of the rigid carrier 801 is coated with an inorganic coating 802. In another embodiment, before the rigid carrier 801 and the flexible substrate 803 are contacted together, at least a portion of the flexible substrate 803 is coated with an inorganic coating.

In one embodiment of the adhesive free carrier assembly, before the rigid carrier and the flexible substrate are contacted together, at least a portion of the rigid carrier is coated with an inorganic coating. The inorganic coating has, in one example, similar chemical composition to the flexible substrate or sticks to the flexible substrate. In one example of the adhesive free carrier assembly, before the rigid carrier and the flexible substrate are contacted together, at least a portion of the flexible substrate is coated with an inorganic coating.

One aspect of the present disclosure is a method for handling and/or processing thin flexible substrates. The method comprises providing a rigid carrier 901, providing a flexible substrate 902, directly contacting the rigid carrier onto the flexible substrate without the use of adhesive to form a carrier assembly 903, fabricating a device on top of the carrier assembly, wherein the device and flexible substrate are linked together 904, and decoupling the rigid carrier from the device-flexible substrate component 905. The thin flexible substrate can, in one example, be glass. In another example, a portion of the perimeter of the rigid carrier is roughened or etched before it is contacted with the flexible substrate. Steps to clean and remove moisture from the substrates and the devices may be performed during processing.

One aspect of the present disclosure is a method for handling and/or processing thin flexible substrates. The method first provides a rigid carrier and a flexible substrate, and then directly contacts the rigid carrier onto the flexible substrate without the use of adhesive to form a carrier assembly. Subsequent steps include the fabrication of a device on top of the carrier assembly such that the device and flexible substrate are linked together, and decoupling the rigid carrier from the device-flexible substrate component. The thin flexible substrate can, in one example, be glass, and the rigid carrier can be sheet of glass or a silicon wafer. In another example, a portion of the perimeter of the rigid carrier is roughened, etched or covered with a decoupler before it is contacted with the flexible substrate. This helps to more efficiently separate the flexible substrate from the rigid carrier. In the presently taught method, before the rigid carrier and the flexible substrate are contacted together, in one example, at least a portion of the rigid carrier or a portion of the flexible substrate is coated with an inorganic coating. Moreover, various lamination means are possible, including pouch lamination, roll lamination and hot press lamination, and process parameters depend on the equipment utilized. In one embodiment, roll lamination is used.

The carrier assembly may further include a device disposed on the flexible glass substrate, and an encapsulation layer covering the device to form a hermetic seal for the device. The device may be at least one of an electronic device, an opto-electronic device, an optical device, a light-emitting device, an OLED device, an organic semiconducting device, an LCD display device, a photovoltaic device, a thin-film sensor, and an evanescent waveguide sensor.

### EXAMPLES

The disclosure, having been generally described, may be more readily understood by reference to the following examples, which are included merely for purposes of illustration of certain aspects and embodiments of the present disclosure, and are not intended to limit the disclosure in any way.

### Rigid Class as a Carrier for Flexible Class With No Adhesives

In one example, 100 μm flexible glass sheets (6″×6″) were obtained from Nippon Electric Glass (NEG) and used in this work. 0.7 mm rigid glass was obtained from Eagle glass from Corning and used as the rigid carrier. First, the inventors of the instant application characterized the surface smoothness of the components using optical profilometry. Shown in Table 1 is the surface roughness for different substrates.

TABLE 1
Surface roughness

| Sample ID | Vendor | Thickness | | Ra (nm) | RMS (nm) | P-to-V (nm) |
|---|---|---|---|---|---|---|
| Eagle | Corning | 0.7 | mm | 0.6 | 0.8 | 12.5 |
| Glass | | | | | | |
| NEG 100 | NEG | 100 | μm | 1.0 | 1.3 | 9.6 |

In one example, flexible glass and rigid glass was used. Flexible glass had dimensions of 150 mm×150 mm×0.1 mm glass, and rigid glass had dimensions of 152.4 mm×152.4 mm×0.7 mm glass. Both the flexible and rigid glass were cleaned by first loading the glass into a Teflon processing boat, then both sides of the glass were rinsed with acetone, followed by rinsing both sides of the glass with isopropanol, and finally rinsing the glass four times with deionized water (by quick immersion into a wet station).

Following this process, the flexible and rigid glass were cleaned further in an ultrasonic bath for 10 minutes in Alconox detergent 8, and again washed four times with deionized water. The glass was then blow dried with nitrogen. Once both the flexible glass and the rigid glass were prepared in this way, the surfaces were so smooth that it allowed for strong coupling between the two once they were placed on top of each other and pressure is applied. Pressure was applied using a roll laminator and by lightly pressing with gloved finger tip (approximately 1 lbs/square inch). Light pressure is sufficient for adhesion; that is, not much pressure is required for the two substrates to adhere together. In another example, a 0.1 mm thick flexible glass was placed on top of a 0.7 mm thick rigid carrier glass such that the flexible glass was placed over the rigid carrier and there was no extension of the flexible glass beyond the surface of the rigid glass with which it is in contact (i.e. no overhang of the flexible substrate over the surface of the rigid carrier). Under these conditions, it was difficult to remove the flexible glass from the rigid glass. The inventors of the instant application attached a Kapton tape to the corner of the surface of the flexible glass in order to peel the flexible glass off of the rigid glass.

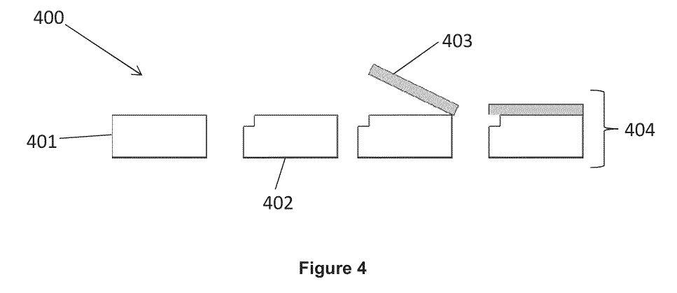

In another example, the flexible glass was positioned such that it is not precisely on top of the rigid carrier. In particular, in this example, one edge of the flexible glass was extended beyond the surface of the rigid glass with which it was in contact (i.e. there is overhang of the flexible substrate over one side of the rigid carrier). Under these conditions, the inventors of the instant application found that they could easily remove the flexible glass from the rigid glass with gloved hands or tweezers. The separation was achieved in this case by pulling up on the flexible glass where it overhangs the rigid glass (see FIG. 4).

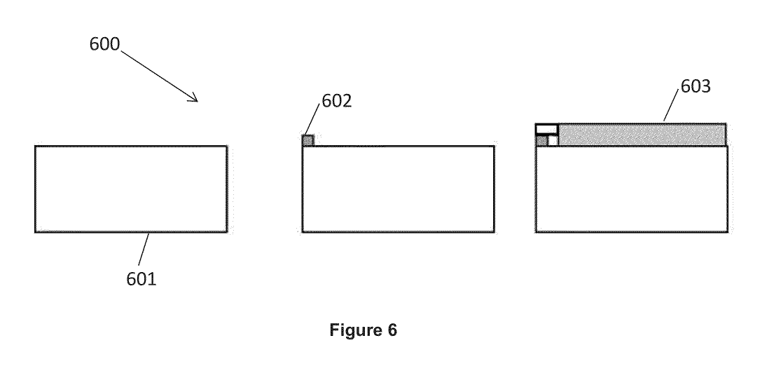

In yet another example, Kapton tape was used as a non-coupling layer around the perimeter of the rigid glass or a portion of the rigid glass so that there is some part of the flexible glass that can be easily removed. The Kapton tape in this experiment was 0.05 mm thick and between 0.03 to 0.2 mm wide. It is contemplated that other sizes and dimensions of the Kapton tape would work. In this example, tweezers can easily slide between Kapton tape and flexible glass in order to remove the tape (see FIG. 6).

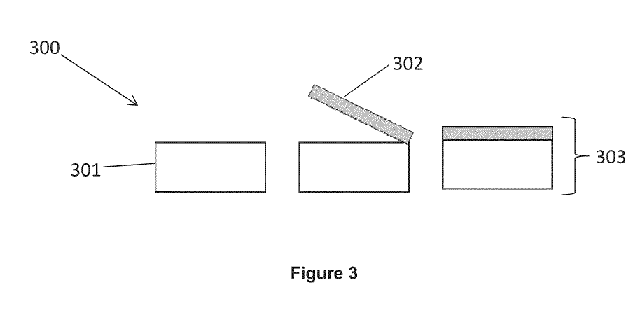

In one example, an adhesive free carrier assembly was formed following the procedure shown in FIG. 3 by laminating the 100 μm flexible glass directly onto the carrier glass to form a carrier assembly. The carrier assembly was then processed as outlined below in Table 1, without any delamination occurring. The following outlined process was used to deposit a heart-pattern of Al film (100 nm) on a 100 um flexible glass using the carrier assembly.

TABLE 1
Processing of the carrier assembly

Wet cleaning including
a. rinsing with deionized water - quick immersion in tank four times
b. bath sonicating in acetone for 10 minutes
c. rinsing with deionized water - quick immersion in tank four times
Thermal baking including
d. baking at 130 C. on a hotplate
e. baking at 200 C. on a hotplate
f. baking at 80 C. inside a vacuum oven (27 inHg)
Vacuum processing steps including
g. transfer in/out of a glovebox through an antechamber;
h. loading part into evaporator & pump down to vacuum of 4 × 10⁻⁶ Torr;
i. depositing 100 nm Al onto the flexible glass through a shadow mask.

In another example, the inventors mechanically etched a 0.7 mm thick rigid glass by sand blasting in order to achieve a rough surface or non-stick surface. Either the perimeter or one corner of the rigid carrier glass was etched in these experiments. The flexible substrate that contacts the rigid carrier glass can then be more easily separated due to the prior processing of the rigid carrier glass.

In yet another example, a one-sided sticky tape was added as a decoupler. In this experiment, a strip of Kapton tape was applied onto a carrier glass along one of the edges. An adhesive free carrier assembly was then formed following the procedure shown in FIG. 6 by laminating a 100 μm flexible glass directly onto the rigid carrier glass to form a carrier assembly. The carrier assembly was then processed as according to the procedure outlined in Table 1, including the steps of wet cleaning, thermal baking and vacuuming. As a result of such processing, the thin flexible glass substrate was able to be easily peeled off from the rigid carrier substrate.

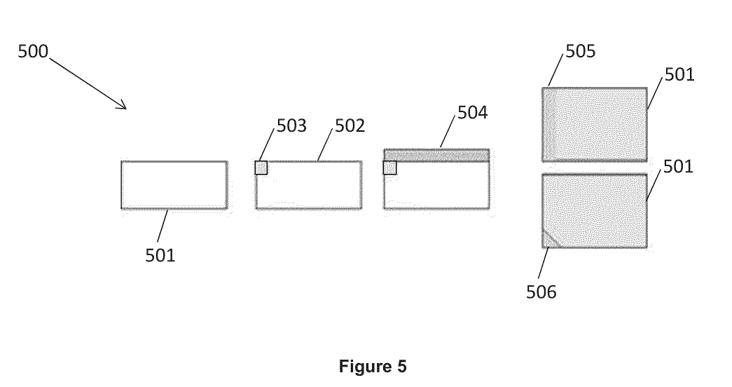

In yet another example, the inventors of the instant application conceived of roughening the perimeter of the rigid carrier so as to aid decoupling. In this experiment, the whole or a portion of the perimeter of a carrier glass was roughened to facilitate the debonding/decoupling process. That is, to help in the separation of the thin flexible substrate from the rigid carrier after the two had come into contact, a portion of the perimeter of the carrier glass was roughened. Different testing parts were made following the procedure shown in FIG. 5 by laminating a 100 μm flexible glass directly onto an engineered rigid carrier glass. FIG. 5 shows a schematic of the adhesive-free carrier assemblies having roughened edges or roughened corner as the decoupler. For roughened edges, all four edges of the rigid glass sheet were sand-blasted to create a rough and frosted surface. The width of the sand-blasted area is approximately 5 mm. For the roughened corner embodiment, one corner of the rigid glass sheet was sand-blasted to create a rough and frosted surface. The area of the triangular sand-blasted surface was approximately 10 mm².

The carrier assembly was formed in each case by laminating the flexible glass to the rigid carrier glass using a roll laminator. And no delamination was observed for both the roughened edges and the roughened corner embodiments. The debonding (or separation) was achieved using a lamination process.

In one example, the adhesive free carrier assembly was for photolithography. Here, a 100 μm flexible glass sheets (6″×6″) over-coated with ITO (120 nm) was obtained from Nippon Electric Glass (NEG). 0.7 mm rigid glass sheets (Eagle glass from Corning) were used as the carrier. The edges of the rigid carrier were roughened by sandblasting. Subsequently, the following steps were performed: wet cleaning using deionized water and acetone; spin-coat photoresist; pattern through photo-mask; developing the photoresist; etching ITO; and removing the photoresist. No delamination was observed for the testing sample. The debonding was achieved using a lamination process.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of ordinary skill in the art upon reviewing the above description. The scope of the invention should, therefore, be determined with reference to the appended claims, along with the full scope of equivalents to which such claims are entitled.

In the appended description, the terms “including” and “in which” are used as the plain-English equivalents of the respective terms “comprising” and “wherein.” Moreover, in the following claims, the terms “first,” “second,” etc. if any, are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person of ordinary skill in the art to practice the embodiments of invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

1. An adhesive free carrier assembly, comprising a rigid carrier and a flexible substrate, wherein the rigid carrier is directly attached to the flexible substrate without the use of an adhesive to form the adhesive free carrier assembly.

2. The adhesive free carrier assembly as according to claim 1, wherein a portion of the flexible substrate extends beyond the rigid substrate.

3. The adhesive free carrier assembly as according to claim 1, wherein a portion of the rigid carrier surface that contacts the flexible substrate is roughened.

4. The adhesive free carrier assembly as according to claim 1, wherein a portion of the perimeter of the rigid carrier is roughened.

5. The adhesive free carrier assembly as according to claim 1, wherein a portion of the perimeter of the rigid carrier is covered with a decoupler.

6. The adhesive free carrier assembly as according to claim 5, wherein the decoupler is from about 10 nanometers to about 1000 micrometers thick.

7. The adhesive free carrier assembly as according to claim 5, wherein the decoupler is about 25 to 100 micrometers thick.

8. The adhesive free carrier assembly as according to claim 5, wherein at least a portion of the flexible substrate is positioned above the decoupler.

9. The adhesive free carrier assembly as according to claim 1, wherein before the rigid carrier and the flexible substrate are contacted together, at least a portion of the rigid carrier is coated with an inorganic coating.

10. The adhesive free carrier assembly as according to claim 9, wherein the inorganic coating has similar chemical composition to the flexible substrate or sticks to the flexible substrate.

11. The adhesive free carrier assembly as according to claim 1, wherein before the rigid carrier and the flexible substrate are contacted together, at least a portion of the flexible substrate is coated with an inorganic coating.

12. An adhesive free carrier assembly, comprising
a rigid carrier having at least a portion of its perimeter etched to provide a step; and
a flexible substrate,
wherein the rigid carrier is directly contacted to the flexible substrate without the use of an adhesive to form the adhesive free carrier assembly, and
wherein at least a portion of the flexible substrate is positioned above said step.

13. An adhesive free carrier assembly, comprising
a rigid carrier having at least a portion of its perimeter etched to provide a step; and
a decoupler covering a portion of the step; and
a flexible substrate,
wherein the rigid carrier is directly contacted to the flexible substrate without the use of an adhesive to form the adhesive free carrier assembly, and
wherein at least a portion of the flexible substrate is positioned above said decoupler.

14. The adhesive free carrier assembly as according to claim 13, wherein the depth of the step and the height of the decoupler are optimized in such a way that the difference in height of the top surface of the decoupler to the rest of the rigid carrier is from about 10 nanometers to 100 micrometers.

15. The adhesive free carrier assembly as according to claim 13, wherein the depth of the step and the height of the decoupler are optimized in such a way that the difference in height of the top surface of the decoupler to the rest of the rigid carrier is about 10 micrometers to 100 micrometers

16. A method for handling and/or processing thin flexible substrates, said method comprising:
a. providing a rigid carrier;
b. providing a flexible substrate;
c. directly contacting the rigid carrier onto the flexible substrate without the use of adhesive to form a carrier assembly;
d. fabricating a device on top of the carrier assembly, wherein the device and flexible substrate are linked together; and
e. decoupling the rigid carrier from the device-flexible substrate component.

17. The method as according to claim 16, wherein the thin flexible substrate is glass.

18. The method as according to claim 16, wherein a portion of the perimeter of the rigid carrier is roughened or etched before it is contacted with the flexible substrate.

19. The method as according to claim 16, wherein a portion of the perimeter of the rigid carrier is covered with a decoupler.

20. The method as according to claim 16, wherein before the rigid carrier and the flexible substrate are contacted together, at least a portion of the rigid carrier is coated with an inorganic coating.

21. The method as according to claim 16, wherein before the rigid carrier and the flexible substrate are contacted together, at least a portion of the flexible substrate is coated with an inorganic coating.
